(19) United States
(12) Patent Application Publication
(10) Pub. No.: US 2015/0088096 A1
(43) Pub. Date: Mar. 26, 2015

(54) SEALABLE MEDICINE DISPENSER HAVING A PRESELECTED DOSAGE AMOUNT

(71) Applicant: Kralmat Medical, LLC, Raleigh, NC (US)

(72) Inventors: Iwona Matthews, Raleigh, NC (US); Violetta Anna Kralka, Holly Springs, NC (US)

(73) Assignee: KRALMAT MEDICAL, LLC, Raleigh, NC (US)

(21) Appl. No.: 14/064,097

(22) Filed: Oct. 25, 2013

Related U.S. Application Data
(60) Provisional application No. 61/882,650, filed on Sep. 26, 2013.

(51) Int. Cl. A61J 7/00

(52) U.S. Cl. CPC A61J 7/0046
USPC 604/514; 604/78

(57) ABSTRACT

A dispenser includes a vessel and an edible first product within the vessel occupying less than the total interior volume such that an unoccupied portion of the interior volume remains for receiving a medication. A seal selectively seals the total interior volume of the vessel. A cup includes a base and an upstanding peripheral wall having a bottom margin connected to the base and an upper margin such that a total interior volume of the cup is defined within the peripheral wall between the base and upper margin. An edible first product occupies a volume that is less than the total interior volume such that an unoccupied portion remains for receiving a medication. An exterior seal engages the upper margin of the wall sealing the total interior volume. The seal is disengaged to permit medicine to be mixed with the edible first product.

### CROSS-REFERENCE TO RELATED APPLICATION

This application claims the benefit of priority of U.S. provisional patent application No. 61/882,650, titled “SEALABLE MEDICINE DISPENSER HAVING A PRESELECTED DOSAGE AMOUNT,” filed on Sep. 26, 2013, which is incorporated herein in its entirety by this reference.

### TECHNICAL FIELD

This disclosure is directed towards a sealable medicine dispenser having a preselected dosage amount. More specifically, this disclosure is directed towards a sealable medicine dispenser that is being provided to aid in ingesting pharmaceutical, neutraceutical, vitamins, capsule, tablet, and other pills and/or medication taken orally.

### BACKGROUND

Many patients struggle with ingesting entire pills. capsules, tablets and other solid medications, and even some liquid medications. In order to aid in ingesting the medication, many times a healthcare provider or patient will crush the pill into a powder form and mix the powdered medication in which a food substrate in order to provide a taste pleasing formulation. For example, the powdered medication may be mixed in with apple sauce and the patient then consumes the apple sauce and powder mixture. In some instances, the pill or medicine may be broken in half or into parts. This mixture is typically provided in a medicine dispenser cup. The cup is then typically disposed of or, in some instances, may be sanitized for reuse. Additionally, sometimes entire, meaning non-crushed, medication, is intermixed with the apple sauce to aid in ingesting.

This practice has many disadvantages. For example, the practice is susceptible for transfer of bacteria and infection when the provider transfers, for example, the apple sauce from the apple sauce container to whatever container is being used to mix the powdered medication in with. Additionally, many times the patient may not want to consume the entire contents of, in the apple sauce example, the apple sauce that the powdered medication is in. If the patient consumes less than the full amount, they don't receive the proper dosage of medication. This is particularly problematic if the health care provider is likely to provide more than a desired amount of the host food. Furthermore, sometimes the medication is placed in the container before the food product is added and the medication adheres to the bottom of the container and is not consumed.

Accordingly, a need exists for a solution to address the disadvantages discussed above.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein is a dispenser for dispensing a medication product. The dispenser includes a vessel that defines a volume. A food product is contained in the vessel. The food product has a volume less than the volume of the vessel such that a void is defined for receiving a medication. A seal is provided for selectively sealing the vessel.

In one or more embodiment, the seal is not re-engageable with the vessel after it is unsealed.

In one or more embodiments, the vessel defines measurement indicators on a side thereof.

In one or more embodiments, the void defines a volume that is greater than or about equal to a dosage amount of medication. The volume may be about the size of a teaspoon.

In one or more embodiments, the dispenser further includes a medication.

In one or more embodiments, the medication is a crushed pill, whole pill, capsule, tablet, liquid medication, or any other form of oral medication.

In one or more embodiments, a method of using the dispenser is provided. The method includes removing the seal, providing a selected dosage of medication into the food product, mixing the food product, and administering the contents to a patient.

In at least one embodiment, a dispenser includes a vessel having a total interior volume; an edible first product within the vessel occupying a first product volume of the vessel that is less than the total interior volume such that an unoccupied portion of the total interior volume remains for receiving a medication; and a seal for selectively sealing the total interior volume of the vessel.

In at least one example, the seal is not re-engageable with the vessel after it is unsealed.

In at least one example, the vessel defines measurement indicators on a side thereof.

In at least one example, the unoccupied portion of the total interior volume is greater than or about equal to a dosage amount of medication.

In at least one example, a medication is provided. In at least one example, the medication is one of a crushed pill, an entire pill, liquid medicine, or any other known oral medication.

In at least one example, an interior seal seals the first product within first product volume and prevents the first product from occupying the unoccupied portion of the total interior volume.

A medicine dispensation system according to at least one embodiment includes: a cup having a base and an upstanding peripheral wall, the wall having a bottom margin connected to the base and an upper margin opposite the bottom margin such that a total interior volume of the cup is defined within the peripheral wall between the base and upper margin of the wall; an edible first product within the cup occupying a first product volume that is less than the total interior volume such that an unoccupied portion of the total interior volume remains for receiving a medication; and an exterior seal engaged with the cup along the upper margin of the wall sealing the total interior volume.

In at least one example, an interior seal seals the first product within first product volume and prevents the first product from occupying the unoccupied portion of the total interior volume. In at least one example, the first product is sealed between the base, the wall, and the interior seal, and the unoccupied portion of the total interior volume is sealed between the interior seal, the wall, and the exterior seal. In at least one example, the interior seal is a one-time use removable or frangible seal.

In at least one example, the exterior seal and interior seal are each approximately planar and are parallel to each other. In at least one example, the base of the cup has a diameter and the upper margin of the wall has a diameter that is greater than the diameter of the base such that the cup widens from the base to the upper margin.

In at least one example, an edible second product portioned to be received in the unoccupied portion of the total interior volume is provided. In at least one example, the second product comprises medicine.

In at least one example, a volume measurement indicator is provided on the wall of the cup.

In at least one example, a shaft and a rotary mixing element attached to the shaft are provided. The mixing element is dimensioned to fit within the cup.

In at least one embodiment, a method of administering a medicine according to at least one embodiment includes providing a cup having a base and an upstanding peripheral wall, the wall having a bottom margin connected to the base and an upper margin opposite the bottom margin such that a total interior volume of the cup is defined within the peripheral wall between the base and upper margin of the wall. In at least one embodiment, the method further includes providing an edible first product within the cup occupying a first product volume that is less than the total interior volume such that an unoccupied portion of the total interior volume remains for receiving a medication. In at least one embodiment, the method further includes providing an exterior seal engaged with the cup along the upper margin of the wall sealing the total interior volume. In at least one embodiment, the method further includes at least partially disengaging the exterior seal from the cup. In at least one embodiment, the method further includes providing a medicine portioned to be received in the unoccupied portion of the total interior volume. In at least one embodiment, the method further includes mixing the medicine and the first product. In at least one embodiment, the method further includes administering the mixed first product and medicine to a patient.

A method according to at least one embodiment further includes providing an interior seal that seals the first product within first product volume and prevents the first product from occupying the unoccupied portion of the total interior volume, and before mixing the medicine and the first product, unsealing the interior seal to permit mixing of the medicine and first product. The edible first product may be food.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a perspective view of a dispenser having a food product and a seal engaged therewith according to one or more embodiments disclosed herein;

FIG. 2 is a perspective view of a dispenser having the seal at least partially disengaged therewith according to one or more embodiments disclosed herein;

FIG. 3 is a perspective view of a dispenser having a medication being intermixed within a food product contained therein according to one or more embodiments disclosed herein;

FIG. 4 is a perspective view of a dispenser having a second sealed assembly according to one or more embodiments disclosed herein; and

FIG. 5 is a flow chart representing a method of administering a medicine according to at least one embodiment disclosed herein.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

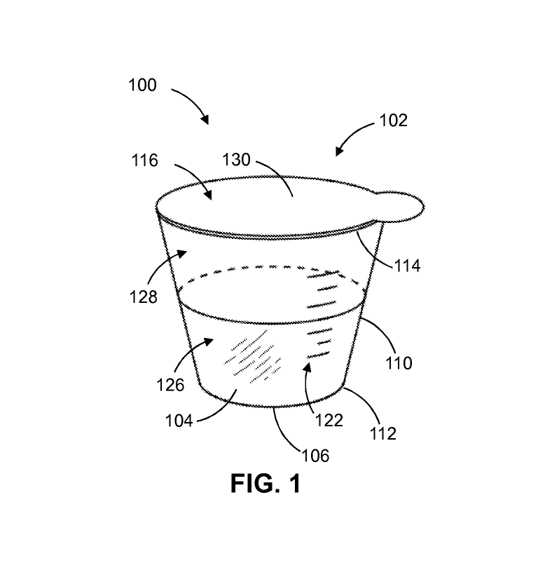

FIG. 1 illustrates a medicine dispensation system 100 according to one or more embodiments disclosed herein. The dispensation system 100 includes a vessel 102 that defines a volume therein for receiving an edible first product 104 such as a food product. In the illustrated embodiment, the vessel 102 is configured as a cup having a base 106 and an upstanding peripheral wall 110. The wall has a bottom margin 112 connected to the base 106 and an upper margin 114 opposite the bottom margin 112 such that a total interior volume 116 of the vessel is defined within the peripheral wall 110 between the base 106 and upper margin 114 of the wall 110. In the illustrated example, the base 106 has a diameter and the upper margin 114 of the wall 110 has a diameter that is greater than the diameter of the base 106 such that the cup widens from the base 106 to the upper margin 114. In one or more embodiments, the vessel 102 may have a volume of about 1 liquid ounce.

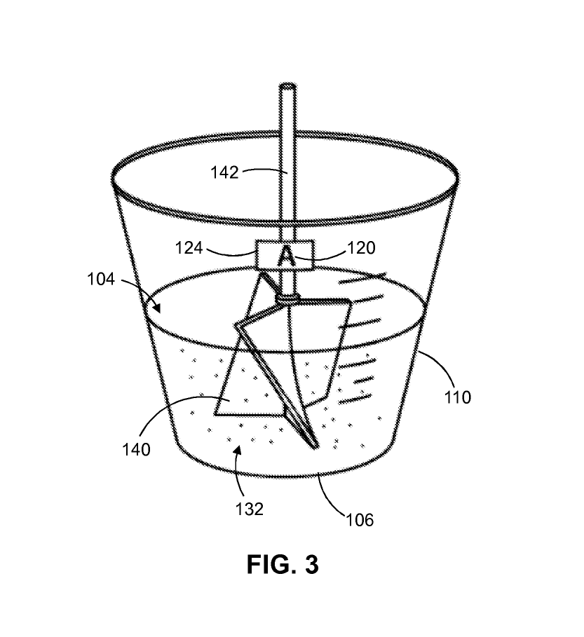

Although the vessel 102 is illustrated as configured as a cup, the vessel 102 may be any appropriately configured vessel and may be, for example, sized similar to a medicine dispenser cup typically packaged with medicine products such as cough syrup or that is used for receiving, storing, and dispensing a collection of pills. The vessel 102 can be formed from medical grade quality material and may be formed of a clear or translucent plastic for viewing the contents therein. Additionally, the vessel 102 may be configured for having a solid color that is not translucent if desired. Indicia 120 (FIG. 3) which may include symbols, graphics, and text for instructional or illustrative purposes may be provided on the vessel 102, for example on an exterior surface of the vessel. For example, a trademark, food product or medicinal content information, and any expiration dates or other data may be provided. The vessel 102 may include a writing area 124 for receiving handwritten or otherwise applied information or content. For example, information such as a patient name and medication being mixed can be written into the writing area 124 of the dispenser.

The vessel 102 may be plastic, medical grade, or any other appropriately configured material. The vessel 102 is illustrated as including measurement indicators 122 along a side of the vessel for measuring or confirming volumes dispensed into or from the vessel. In the illustrated embodiment, the measurement indicators 122 are configured as horizontal lines vertically positioned according to corresponding volume increments. Corresponding numeric or symbolic indicia may be present with the spaced lines to inform a user as to the volume scale of the indicators.

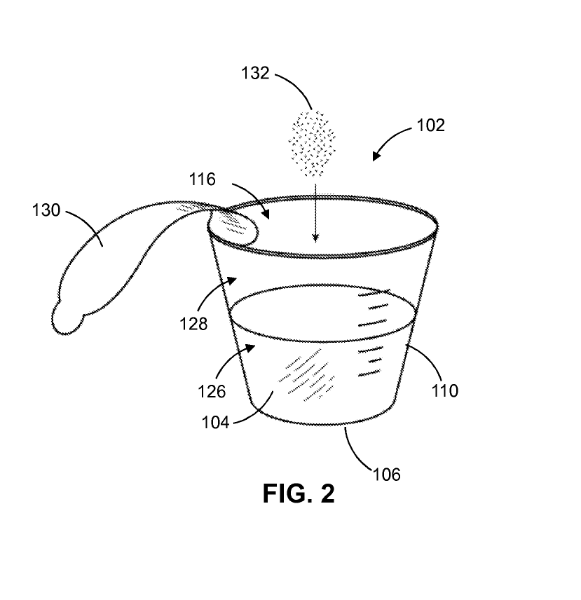

The vessel 102 is configured to have an edible first product 104 such as a food product contained therein. The edible first product 104 may be any appropriately configured product into which a medicine can be intermixed or dissolved. For example, the edible first product 104 may be apple sauce, edible gelatin, pudding, yogurt, ice cream, juices, and the like. The edible first product 104 is configured for occupying a first product volume 126 (FIG. 2) of the vessel 102, but not the total interior volume 116, such that an unoccupied portion 128 of the total interior volume 116 remains for receiving a medication. In this manner, the unoccupied portion 128 of the total interior volume is formed where no edible first product 104 is initially contained. This unoccupied portion 128 is provided for allowing space for receiving a medication product. The unoccupied portion 128 has a volume that is either equal to, or in excess of, a desired dosage volume of medication. The unoccupied portion 128 may be initially prepared as a vacuum or void or may be filled with air or other gas.

A seal 130 is provided for selectively sealing the vessel 102. In this manner, the seal 130 is provided after the edible first product 104 is dispensed into the vessel 102 to seal the contents therein. The seal 130 may be a thin metallic seal with an adhesive on a vessel-facing side thereof, such as, for example, a plasticized aluminum foil seal with medical grade adhesive adhering the seal 130 to the vessel 102. In the illustrated embodiment, the seal 130 constitutes an exterior seal engaged with the vessel along the upper margin 114 of the wall 110 sealing the total interior volume 116 from contamination or loss of contents.

Additionally, any other type of seal may be employed, including a lid that can be twisted or otherwise disengaged from the vessel 102 when desired. In some embodiments, the seal 20 is not configured to be engaged with the vessel 102 once disengaged, such that the seal constitutes a one-time use removable, breakable, or frangible seal that, once broken or disengaged, cannot be readily reapplied. In this manner, the integrity and security of the edible first product 104 can be confirmed by presence and engagement of the seal.

In use, the medicine dispensation system 100 is provided as illustrated in FIG. 1. The seal 130 is then at least partially disengaged or removed from the vessel 102 as illustrated in FIG. 2. In the embodiment illustrated in FIG. 2, the seal 130 is at least partially peeled away from the vessel 102, although other seal designs may be employed. An ingestible second product 132 such as a medication is then placed into the edible first product 104. The ingestible second product 132 may be a powdered, liquid, or crushed medication. For example, a pill that a patient could not otherwise swallow could be crushed or ground and then placed into the edible first product 104. An entire pill, capsule, tablet, or any other oral medication can also be used. Then the ingestible second product 132 and edible first product 104 are mixed, for example as shown in FIG. 3, in preparation for consumption, for example by a patient.

In at least one embodiment, a rotary mixing element 140 (FIG. 3) attached to the end of a shaft 142 is provided with the medicine dispensation system 100. The mixing element 140 in the illustrated embodiment includes mixing blades attached to the shaft 142. The mixing element 140 is dimensioned to fit within the vessel 102 for mixing the food product 104 by rotation of the shaft 142 and rotary mixing element 140. The mixture prepared by intermixing the ingestible second product 132 and edible first product 104 product is then given to a patient.

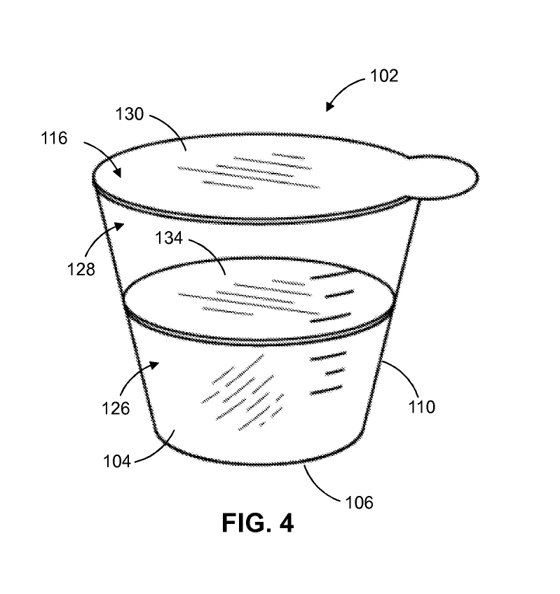

FIG. 4 illustrates an alternate embodiment in which a second seal 134 is provided. This has the advantage of adding an additional layer of sealing protection, as well as reducing the chance for spillage or having food product projected out of the vessel 102. In the illustrated embodiment, the second seal 134 constitutes an interior seal that seals the edible first product 104 within the first product volume 126 and prevents the edible first product 104 from occupying the unoccupied portion 128 of the total interior volume 116, particularly before mixing with an ingestible second product such as a medication. In the illustrated embodiment, the first product 104 is sealed between the base 106, the wall 110, and the interior seal 134, and the unoccupied portion 128 of the total interior volume 116 is sealed between the interior seal 134, the wall 110, and the exterior seal 130. The interior seal 134 may be a one-time use removable or frangible seal. Furthermore, in the illustrated example, the exterior seal 130 and interior seal 134 are each approximately planar and are parallel to each other. Before mixing an ingestible second product 132 such as a medication with the edible first product 104, the interior seal 134 is unsealed to permit mixing of the medicine and first product.

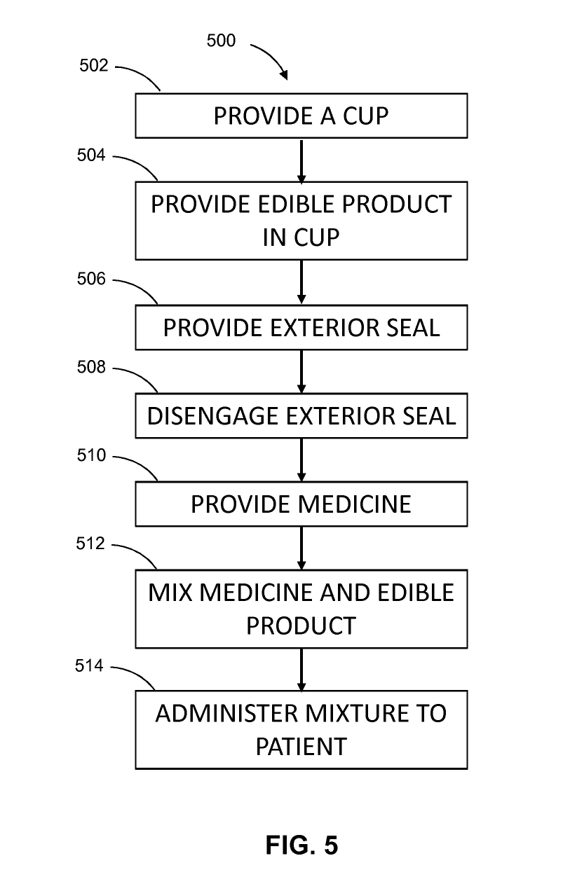

A method 500 of administering a medicine according to at least one embodiment is represented by a flow chart in FIG. 5. Step 502 includes providing a cup having a base and an upstanding peripheral wall, the wall having a bottom margin connected to the base and an upper margin opposite the bottom margin such that a total interior volume of the cup is defined within the peripheral wall between the base and upper margin of the wall. Step 504 includes providing an edible first product within the cup occupying a first product volume that is less than the total interior volume such that an unoccupied portion of the total interior volume remains for receiving a medication. Step 506 includes providing an exterior seal engaged with the cup along the upper margin of the wall sealing the total interior volume. Step 508 includes at least partially disengaging the exterior seal from the cup. Step 510 includes providing a medicine portioned to be received in the unoccupied portion of the total interior volume. Step 512 includes mixing the medicine and the first product. Step 514 includes administering the mixed first product and medicine to a patient.

A method according to at least one embodiment may further include providing an interior seal that seals the first product within first product volume and prevents the first product from occupying the unoccupied portion of the total interior volume, and before mixing the medicine and the first product, unsealing the interior seal to permit mixing of the medicine and first product. The edible first product may be food.

The embodiments disclosed herein for the medicine dispensation system 100 and method 500 have the apparent advantage of reducing the occurrence of bacterial or viral transfer associated with conventional methods previously described, may eliminate waste associated with such conventional methods, and may reduce the time needed for administering medication by a health care provider.

Features from one embodiment or aspect may be combined with features from any other embodiment or aspect in any appropriate combination.

While the embodiments have been described in connection with the various embodiments of the various figures, it is to be understood that other similar embodiments may be used or modifications and additions may be made to the described embodiments for performing the same function without deviating therefrom. Therefore, the disclosed embodiments should not be limited to any single embodiment, but rather should be construed in breadth and scope in accordance with the appended claims.

1. A dispenser comprising:
a vessel having a total interior volume;
an edible first product within the vessel occupying a first product volume of the vessel that is less than the total interior volume such that an unoccupied portion of the total interior volume remains for receiving a medication; and
a seal for selectively sealing the total interior volume of the vessel.

2. The dispenser according to claim 1, wherein the seal is not re-engageable with the vessel after it is unsealed.

3. The dispenser according to claim 1, wherein the vessel defines measurement indicators on a side thereof.

4. The dispenser according to claim 1, wherein the unoccupied portion of the total interior volume is greater than or about equal to a dosage amount of medication.

5. The dispenser according to claim 1, further comprising a medication.

6. The dispenser according to claim 5, wherein the medication is one of a crushed pill, an entire pill, liquid medicine, a partial pill, and an oral medication.

7. The dispenser according to claim 1, further comprising an interior seal that seals the first product within first product volume and prevents the first product from occupying the unoccupied portion of the total interior volume.

8. A medicine dispensation system comprising:
a cup having a base and an upstanding peripheral wall, the wall having a bottom margin connected to the base and an upper margin opposite the bottom margin such that a total interior volume of the cup is defined within the peripheral wall between the base and upper margin of the wall;
an edible first product within the cup occupying a first product volume that is less than the total interior volume such that an unoccupied portion of the total interior volume remains for receiving a medication; and
an exterior seal engaged with the cup along the upper margin of the wall sealing the total interior volume.

9. A medicine dispensation system according to claim 8, further comprising an interior seal that seals the first product within first product volume and prevents the first product from occupying the unoccupied portion of the total interior volume.

10. A medicine dispensation system according to claim 9, wherein:
the first product is sealed between the base, the wall, and the interior seal, and
the unoccupied portion of the total interior volume is sealed between the interior seal, the wall, and the exterior seal.

11. A medicine dispensation system according to claim 9, wherein the interior seal is a one-time use removable or frangible seal.

12. A medicine dispensation system according to claim 11, wherein the exterior seal and interior seal are each approximately planar and are parallel to each other.

13. A medicine dispensation system according to claim 12, wherein the base of the cup has a diameter and the upper margin of the wall has a diameter that is greater than the diameter of the base such that the cup widens from the base to the upper margin.

14. A medicine dispensation system according to claim 8, further comprising an edible second product portioned to be received in the unoccupied portion of the total interior volume.

15. A medicine dispensation system according to claim 14, wherein the second product comprises medicine.

16. A medicine dispensation system according to claim 8, further comprising a volume measurement indicator on the wall of the cup.

17. A medicine dispensation system according to claim 8, further comprising a shaft and a rotary mixing element attached to the shaft, the mixing element dimensioned to fit within the cup.

18. A method of administering a medicine comprising:
providing a cup having a base and an upstanding peripheral wall, the wall having a bottom margin connected to the base and an upper margin opposite the bottom margin such that a total interior volume of the cup is defined within the peripheral wall between the base and upper margin of the wall;
providing an edible first product within the cup occupying a first product volume that is less than the total interior volume such that an unoccupied portion of the total interior volume remains for receiving a medication, wherein the unoccupied portion is at least the volume of a desired dosage volume of the medication;
providing an exterior seal engaged with the cup along the upper margin of the wall sealing the total interior volume;
at least partially disengaging the exterior seal from the cup;
providing a medicine portioned to be received in the unoccupied portion of the total interior volume;
mixing the medicine and the first product; and
administering the mixed first product and medicine to a patient.

19. A method according to claim 18, further comprising:
providing an interior seal that seals the first product within first product volume and prevents the first product from occupying the unoccupied portion of the total interior volume; and
before mixing the medicine and the first product, unsealing the interior seal to permit mixing of the medicine and first product.

20. A method according to claim 19, wherein the edible first product comprises food.
